(19) United States
(12) Patent Application Publication
(10) Pub. No.: US 2010/0047495 A1
(43) Pub. Date: Feb. 25, 2010

(54) MULTILAYER TUBE FOR TRANSPORTING WATER OR GAS

(75) Inventors: Anthony Bonnet, Beaumont Le Roger (FR); Michael Werth, Bernay (FR)

Correspondence Address: ARKEMA INC.;PATENT DEPARTMENT - 26TH FLOOR, 2000 MARKET STREET, PHILADELPHIA, PA, 19103-3222, US

(73) Assignee: ARKEMA FRANCE, COLOMBES (FR)

(21) Appl. No.: 12/090,163

(22) PCT Filed: Oct. 12, 2006
(86) PCT No.: PCT/FR2006/051027

§ 371 Date: Aug. 15, 2008

(30) Foreign Application Priority Data
Oct. 13, 2005 (FR) 0510440
Dec. 29, 2005 (US) 60/754887

(51) Int. Cl. B32B 1/08

(52) U.S. Cl. 428/35.9; 428/36.91

(57) ABSTRACT

The invention relates to multilayer tube comprising (from the inside to the outside of the tube): an optional layer (C₁) consisting of at least one fluorinated polymer; a layer (C₂) consisting of a mixture containing at least one functionalized fluorinated polymer and at least one flexible fluorinated polymer having a tensile modulus of between 50 and 1000 MPa (measured in accordance with ISO R 527 standard at 23° C.), advantageously between 100 and 750 MPa and preferably between 200 and 600 MPa; an optional layer (C₃) of adhesive binder; a layer (C₄) consisting of at least one polyolefin or a mixture of at least one polyolefin with at least one functionalized polyolefin; a barrier layer (C₅); and an optional layer (C₆) consisting of least one polyolefin.

This application claims benefit, under U.S.C. §119 or §365 of PCT application PCT/FR2006/051027, filed Oct. 12, 2006; French Application Number FR 05.10440, filed Oct. 13, 2005; and US Provisional Application U.S. 60/754,887, filed Dec. 29, 2005.

### FIELD OF THE INVENTION

The present invention relates to a multilayer pipe comprising a functionalized fluoropolymer layer, a polyolefin layer and a barrier layer. The polyolefin may be a polyethylene, especially high-density polyethylene (HDPE) or a crosslinked polyethylene (denoted by XPE). The pipe may be used for transporting liquids, in particular hot water, or gas. The invention also relates to the uses of this pipe.

### TECHNICAL PROBLEM

Steel or cast iron pipes are being increasingly replaced with equivalents made of plastic. Polyolefins, especially polyethylenes, are very widely used thermoplastics as they exhibit good mechanical properties, they can be easily converted and allow pipes to be welded together easily. Polyolefins are widely used for the manufacture of pipes for transporting water or town gas. When the gas is under a high pressure (>10 bar, or higher), it is necessary for the polyolefin to mechanically withstand the stresses exerted by the pressurized gas.

In addition, the polyolefin may be exposed to an aggressive chemical environment. For example, in the case of water transport, the water may contain aggressive additives or chemicals (for example, ozone, and chlorinated derivatives used for purifying water such as bleach, which are oxidizing, especially when hot). These additives or chemicals may damage the polyolefin over the course of time, especially when the water transported is at a high temperature (this is the case in heating circuits or else in water systems for which the water is heated to a high temperature in order to eliminate germs, bacteria or microorganisms). One problem that the invention aims to solve is therefore to develop a chemically resistant pipe.

Another problem that the invention aims to solve is that the pipe must have barrier properties. The term “barrier” is understood to mean the fact that the pipe reduces the rate of migration into the transported fluid of contaminants present in the external environment or else contaminants (such as antioxidants or polymerization residues) present in the polyolefin. The term “barrier” also means the fact that the pipe reduces the rate of migration of oxygen or of additives present in the transported fluid into the polyolefin layer.

It is also necessary for the pipe to have good mechanical properties, in particular good impact strength, and for the layers to adhere well to one another (no delamination).

The Applicant has developed a multilayer pipe that solves the stated problems. This pipe has, in particular, good chemical resistance to the transported fluid and also the abovementioned barrier properties.

### PRIOR ART

Document EP 1484346 published on 8 Dec. 2004 describes multilayer structures that include a radiation-grafted fluoropolymer. The structures may be in the form of bottles, tanks, containers or hoses. The structure of the multilayer pipe according to the invention does not appear in this document.

Document EP 1541343 published on 8 Jun. 2005 describes a multilayer structure based on a fluoropolymer modified by radiation grafting in order to store or transport chemicals. In this application, the term “chemicals” should be understood to mean products that are corrosive or dangerous, or else products whose purity has to be maintained. The structure of the multilayer pipe according to the invention does not appear in this document.

Document U.S. Pat. No. 6,016,849 published on 25 Jul. 1996 describes a plastic pipe in which the adhesion between the inner layer and the outer protective layer is between 0.2 and 0.5 N/mm. There is no mention of a fluoropolymer modified by radiation grafting.

Documents US 2004/0206413 and WO 2005/070671 describe a multilayer pipe comprising a metal sheath. There is no mention of a fluoropolymer modified by radiation grafting.

In these documents from the prior art, multilayer pipes comprising a polyolefin layer, a functionalized fluoropolymer layer and a barrier layer are not described.

### BRIEF DESCRIPTION OF THE INVENTION

The invention relates to a multilayer pipe as defined in claim 1, 23 or 24. It also relates to the use of the pipe in transporting water or a gas, or a fuel, and also to a radiant heating system comprising at least one multilayer pipe of the invention.

The invention may be better understood on reading the following detailed description of non-limiting illustrative examples of the invention and on examining the appended figure. The prior French application FR 05/10440 and also the provisional application U.S. 60/754,887, the priorities of which are claimed, are incorporated here for reference.

### FIGURE

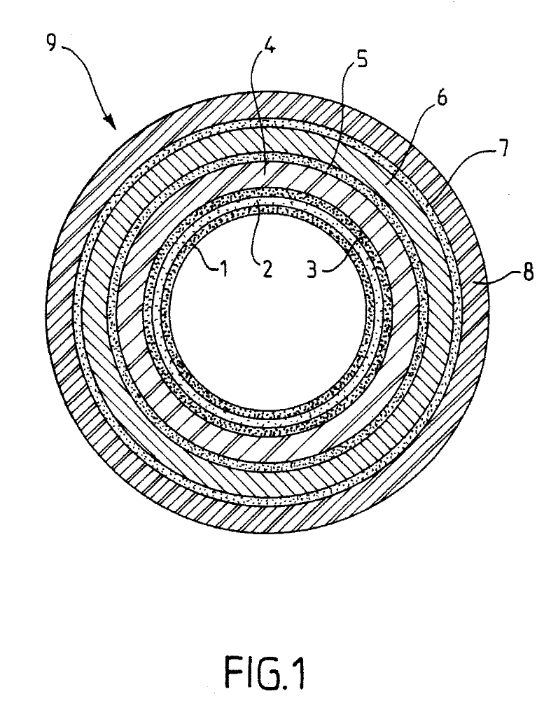

FIG. 1 shows a cross-sectional view of a multilayer pipe 9 according to one of the embodiments of the invention. It is a cylindrical pipe having several concentric layers, referenced 1 to 8. The layers are arranged one against the other in the order indicated from 1→8:
layer 1: layer C₁ comprising a fluoropolymer;
layer 2: layer C₂ comprising the functionalized fluoropolymer+flexible fluoropolymer blend;
layer 3: adhesion tie layer C₃;
layer 4: layer C₄ comprising a polyolefin;
layer 5: adhesion tie layer;
layer 6: barrier layer C₅;
layer 7: adhesion tie layer; and
layer 8: layer C₆ comprising a polyolefin.

### DETAILED DESCRIPTION OF THE INVENTION

As regards the fluoropolymer, this thus denotes any polymer having, in its chain, at least one fluoromonomer chosen from compounds containing a vinyl group capable of opening in order to be polymerized and which contains, directly attached to this vinyl group, at least one fluorine atom, one fluoroalkyl group or one fluoroalkoxy group.

As examples of fluoromonomers, mention may be made of vinyl fluoride; vinylidene fluoride (VDF, CH₂═CF₂); trifluoroethylene (VF₃); chlorotrifluoroethylene (CTFE); 1,2-difluoroethylene; tetrafluoroethylene (TFE); hexafluoropropylene (HFP); perfluoroalkylvinyl ethers such as perfluoromethylvinyl ether (PMVE), perfluoroethylvinyl ether (PEVE) and perfluoropropylvinyl ether (PPVE); perfluoro(1,3-dioxole); perfluoro(2,2-dimethyl-1,3-dioxole) (PDD); the product of formula CF₂═CFOCF₂CF(CF₃)OCF₂CF₂X in which X is SO₂F, CO₂H, CH₂OH, CH₂OCN or CH₂OPO₃H; the product of formula CF₂═CFOCF₂CF₂SO₂F; the product of formula F(CF₂)ₙCH₂OCF═CF₂ in which n is 1, 2, 3, 4 or 5; the product of formula R₁CH₂OCF═CF₂ in which R₁ is hydrogen or F(CF₂)_{z} and z is equal to 1, 2, 3 or 4; the product of formula R₃OCF═CH₂ in which R₃ is F(CF₂)_{z}— and z is 1, 2, 3 or 4; perfluorobutylethylene (PFBE); 3,3,3-trifluoropropene and 2-trifluoromethyl-3,3,3-trifluoro-1-propene.

The fluoropolymer may be a homopolymer or a copolymer; it may also comprise non-fluorinated monomers such as ethylene.

By way of example, the fluoropolymer is chosen from:
vinylidene fluoride homopolymers and copolymers (PVDF) preferably containing at least 50% by weight of VDF, the copolymer being chosen from chlorotrifluoroethylene (CTFE), hexafluoropropylene (HFP), trifluoroethylene (VF3) and tetrafluoroethylene (TFE);
ethylene/TFE copolymers (ETFE);
homopolymers and copolymers of trifluoroethylene (VF3); and
copolymers, and especially terpolymers, combining the residues of chlorotrifluoroethylene (CTFE), tetrafluoroethylene (TFE), hexafluoropropylene (HFP) and/or ethylene units and optionally VDF and/or VF3 units.

Advantageously, the fluoropolymer is a PVDF homopolymer or copolymer. This is because such a fluoropolymer exhibits good chemical resistance, especially to UV radiation and to chemicals, and is easily converted (more easily than PTFE or ETFE-type copolymers). Preferably, the PVDF contains, by weight, at least 50%, more preferably at least 75% and better still at least 85% of VDF. The comonomer is advantageously HFP.

Advantageously, the PVDF has a viscosity ranging from 100 Pa·s to 2000 Pa·s, the viscosity being measured at 230° C., at a shear rate of 100 s⁻¹ using a capillary rheometer. This is because these PVDFs are well suited to extrusion and to injection molding. Preferably, the PVDF has a viscosity ranging from 300 Pa·s to 1200 Pa·s, the viscosity being measured at 230° C., at a shear rate of 100 s⁻¹ using a capillary rheometer.

Thus, the PVDFs sold under the brand name KYNAR® 710 or 720 are perfectly suitable for this formulation.

As regards the flexible fluoropolymer, this is a fluoropolymer having a tensile modulus between 50 and 1000 MPa, advantageously between 100 and 750 MPa and preferably between 200 and 600 MPa (measured according to the ISO R 527 standard at 23° C.).

As regards the functionalized fluoropolymer, this is a fluoropolymer bearing at least one functional group chosen from the following groups: carboxylic acid, carboxylic acid salt, carbonate, carboxylic acid anhydride, epoxide, carboxylic acid ester, silyl, alkoxysilane, carboxylic acid amide, hydroxy or isocyanate. It is a copolymer comprising at least one fluoromonomer and at least one unsaturated monomer bearing a functional group such as defined. The functional group is introduced into the fluoropolymer either by copolymerization or by grafting with a monomer bearing a functional group such as defined.

The functionalized fluoropolymer may be obtained by copolymerizing a fluoromonomer with at least one unsaturated monomer bearing a functional group and optionally at least one other comonomer. For example, the functionalized polymer may be a PVDF comprising monomer units of VDF and of a monoesterified unsaturated diacid or vinylene carbonate such as is described in document U.S. Pat. No. 5,415,958. Another example of a functionalized fluoropolymer is that of a PVDF comprising monomer units of VDF and of itaconic or citraconic anhydride such as is described in document U.S. Pat. No. 6,703,465 B2. The functionalized fluoropolymer may be prepared by a process in emulsion, in suspension or in solution.

The functionalized fluoropolymer may be obtained by radiation grafting of at least one unsaturated monomer (described later on) onto a fluoropolymer. In this case, to simplify matters this will be referred to as a radiation-grafted fluoropolymer.

The process for obtaining the radiation-grafted fluoropolymer is the following.

a) The fluoropolymer is first melt-blended with the unsaturated monomer. This is carried out by any melt-blending technique known in the prior art. The blending step is carried out in any blending device, such as extruders or mixers used in the thermoplastics industry. Preferably, an extruder will be used to make the blend in the form of granules. The grafting therefore takes place on a blend (throughout the mass) and not on the surface of a powder such as is described, for example, in document U.S. Pat. No. 5,576,106.
b) Next, the fluoropolymer/unsaturated monomer blend is irradiated (β or γ irradiation) in the solid state using an electron or photon source with an irradiation dose between 10 and 200 kGray, preferably between 10 and 150 kGray. The blend may, for example, be packaged in polyethylene bags, the air is expelled therefrom, then the bags are sealed.

Advantageously, the dose is between 2 and 6 Mrad and preferably between 3 and 5 Mrad. It is particularly preferred to carry out the irradiation in a cobalt-60 bomb.

The grafted unsaturated monomer content is, by weight, between 0.1 and 5% (that is to say that the grafted unsaturated monomer corresponds to 0.1 to 5 parts per 99.9 to 95 parts of fluoropolymer), advantageously from 0.5 to 5%, preferably from 0.9 to 5%. The grafted unsaturated monomer content depends on the initial content of the unsaturated monomer in the fluoropolymer/unsaturated monomer blend to be irradiated. It also depends on the efficiency of the grafting, and therefore on the duration and energy of the irradiation.

c) The unsaturated monomer that has not been grafted and the residues released by the grafting, especially HF, may then be optionally removed. The latter step may be necessary if the non-grafted unsaturated monomer is liable to impair the adhesion or else cause toxicological problems. This operation may be carried out using techniques known to a person skilled in the art. A vacuum degassing operation may be applied, optionally applying heating at the same time. It is also possible to dissolve the modified fluoropolymer in an appropriate solvent such as, for example, N-methylpyrrolidone, then to precipitate the polymer in a non-solvent, for example in water or else in an alcohol, or else to wash the modified fluoropolymer using a solvent that is inert with respect to the fluoropolymer and the grafted functional groups. For example, when maleic anhydride is grafted, it is possible to wash with chlorobenzene.

One of the advantages of this radiation-grafting process is that it is possible to obtain higher grafted unsaturated monomer contents than with the conventional grafting processes using a radical initiator. Thus, with this grafting process, it is typically possible to obtain contents of greater than 1% (1 part of unsaturated monomer per 99 parts of fluoropolymer), or even greater than 1.5%, something that is not possible with a conventional grafting process carried out in an extruder.

Moreover, the radiation grafting takes place “cold” typically at temperatures below 100° C., or even 50° C., so that the fluoropolymer/unsaturated monomer blend is not in the melt state, as in the case of a conventional grafting process carried out in an extruder, but is in the solid state. One essential difference is therefore that, in the case of a semicrystalline fluoropolymer (as is the case with PVDF for example), the grafting takes place in the amorphous phase and not in the crystalline phase, whereas homogeneous grafting occurs in the case of melt-grafting in an extruder. The unsaturated monomer is therefore not distributed along the fluoropolymer chains in the same way as in the case of radiation grafting and in the case of grafting carried out in an extruder. The modified fluoropolymer therefore has a different distribution of unsaturated monomer among the fluoropolymer chains compared with a product obtained by grafting carried out in an extruder.

During this grafting step, it is preferable to prevent oxygen from being present. It is therefore possible to remove the oxygen by flushing the fluoropolymer/unsaturated monomer blend with nitrogen or argon.

The fluoropolymer modified by radiation grafting has the very good chemical resistance and very good oxidation resistance, and also the good thermomechanical behavior, of the fluoropolymer before its modification.

As regards the unsaturated monomer, this has a C═C double bond and also at least one polar functional group that may be one of the following functional groups:
carboxylic acid;
carboxylic acid salt;
carboxylic acid anhydride;
epoxide;
carboxylic acid ester;
silyl;
alkoxysilane;
carboxylic acid amide;
hydroxyl; and
isocyanate.

It is also possible to envisage using mixtures of several unsaturated monomers.

Unsaturated carboxylic acids having 4 to 10 carbon atoms and their functional derivatives, particularly their anhydrides, are particularly preferred unsaturated monomers. Mention may be made, by way of examples of unsaturated monomers, of methacrylic acid, acrylic acid, maleic acid, fumaric acid, itaconic acid, citraconic acid, undecylenic acid, allylsuccinic acid, cyclohex-4-ene-1,2-dicarboxylic acid, 4-methylcyclohex-4-ene-1,2-dicarboxylic acid, bicyclo[2.2.1]hept-5-ene-2,3-dicarboxylic acid, x-methylbicyclo[2.2.1]hept-5-ene-2,3-dicarboxylic acid, zinc, calcium or sodium undecylenate, maleic anhydride, itaconic anhydride, citraconic anhydride, dichloromaleic anhydride, difluoromaleic anhydride, itaconic anhydride, crotonic anhydride, glycidyl acrylate or methacrylate, allylglycidyl ether, vinylsilanes such as vinyltrimethoxysilane, vinyltriethoxysilane, vinyltriacetoxysilane and γ-methylacryloxypropyltrimethoxysilane.

Other examples of unsaturated monomers comprise C₁-C₈ alkyl esters or glycidyl ester derivatives of unsaturated carboxylic acids such as methyl acrylate, methyl methacrylate, ethyl acrylate, ethyl methacrylate, butyl acrylate, butyl methacrylate, glycidyl acrylate, glycidyl methacrylate, monoethylmaleate, diethylmaleate, monomethyl fumarate, dimethyl fumarate, monomethyl itaconate and diethyl itaconate; amide derivatives of unsaturated carboxylic acids such as acrylamide, methacrylamide, maleamide, malediamide, N-ethylmaleamide, N,N-diethylmaleamide, N-butylmaleamide, N,N-dibutylmaleamide, fumaramide, fumardiamide, N-ethylfumaramide, N,N-diethylfumaramide, N-butylfumaramide and N,N-dibutylfumaramide; imide derivatives of unsaturated carboxylic acids such as maleimide, N-butylmaleimide and N-phenylmaleimide; and metal salts of unsaturated carboxylic acid such as sodium acrylate, sodium methacrylate, potassium acrylate, potassium methacrylate and zinc, calcium or sodium undecylenate.

Excluded from unsaturated monomers are those that have two C═C double bonds which could result in crosslinking of the fluoropolymer, such as for example diacrylates or triacrylates. From this point of view, maleic anhydride just like zinc, calcium and sodium undecylenates constitute good graftable compounds as they have little tendency to homopolymerize or even to cause crosslinking.

Advantageously, maleic anhydride is used. This is because this monomer offers the following advantages:
it is solid and may be easily introduced with the fluoropolymer granules in order to prepare the blend to be melted;
it allows good adhesion properties to be obtained;
it is particularly reactive with respect to epoxide or hydroxyl functional groups; and
unlike other unsaturated monomers such as (meth)acrylic acid or acrylic esters, it does not homopolymerize and does not have to be stabilized.

In the blend to be irradiated, the amount of fluoropolymer is, by weight, between 80 and 99.9% per 0.1 to 20% respectively of unsaturated monomer. Preferably, the amount of fluoropolymer is from 90 to 99% per 1 to 10% respectively of unsaturated monomer.

As regards the polyolefin, this term denotes a polymer predominantly comprising ethylene and/or propylene units. It may be a polyethylene homopolymer or copolymer, the comonomer being chosen from propylene, butene, hexene or octene. It may also be a polypropylene homopolymer or copolymer, the comonomer being chosen from ethylene, butene, hexene or octene.

The polyethylene may especially be high-density polyethylene (HDPE), low-density polyethylene (LDPE), linear low-density polyethylene (LLDPE) or very low-density polyethylene (VLDPE). The polyethylene may be obtained using a Ziegler-Natta, Phillips or metallocene-type catalyst or using the high-pressure process. The polypropylene is an isotactic or syndiotactic polypropylene.

It may also be a crosslinked polyethylene (denoted by XPE) The XPE has, compared to a non-crosslinked PE, better mechanical properties (especially good crack resistance) and a better chemical resistance. The crosslinked polyethylene may, for example, be a polyethylene comprising hydrolyzable silane groups (as described in Applications WO 01/53367 or US 2004/0127641 A1) which has then been crosslinked after the silane groups have reacted together. The reaction between the Si—OR silane groups results in Si—O—Si bonds that link the polyethylene chains together. The content of hydrolyzable silane groups may be at least 0.1 hydrolyzable group per 100—CH₂— units (determined by infrared analysis). The polyethylene may also be crosslinked by radiation, for example gamma radiation. It may also be a polyethylene crosslinked using a peroxide-type radical initiator. It will therefore be possible to use a type-A XPE (crosslinking using a radical initiator), a type-B XPE (crosslinking using silane groups) or a type-C XPE (radiation crosslinking).

It may also be what is called a bimodal polyethylene, that is to say one composed of a blend of polyethylenes having different average molecular weights, as taught in document WO 00/60001. Bimodal polyethylene makes it possible, for example, to obtain a very advantageous compromise of impact and stress-cracking resistance, good rigidity and good pressure-withstand capability.

For pipes that have to be pressure-resistant, especially pipes for transporting pressurized gas or for transporting water, it may be advantageous to use a polyethylene that has good resistance to slow crack growth (SCG) and to rapid crack propagation (RCP). The HDPE XS 10 B grade sold by Total Petrochemicals exhibits good (slow or rapid) crack resistance. This is an HDPE containing hexene as a comonomer, having a density of 0.959 g/cm³ (ISO 1183), an MI-5 of 0.3 dg/min (ISO 1133), an HLMI of 8 dg/min (ISO 1133), a long-term hydrostatic strength of 11.2 MPa according to ISO/DIS 9080, a slow crack growth resistance on notched pipes of greater than 1000 hours according to ISO/DIS 13479.

As regards the functionalized polyolefin, this term denotes a copolymer of ethylene and/or propylene with at least one unsaturated polar monomer. This unsaturated polar monomer may, for example, be chosen from:
C₁-C₈ alkyl (meth)acrylates, especially methyl, ethyl, propyl, butyl, 2-ethylhexyl, isobutyl or cyclohexyl (meth)acrylate;
unsaturated carboxylic acids, their salts and their anhydrides, especially acrylic acid, methacrylic acid, maleic anhydride, itaconic anhydride and citraconic anhydride;
unsaturated epoxides, especially aliphatic glycidyl esters and ethers such as allyl glycidyl ether, vinyl glycidyl ether, glycidyl maleate, glycidyl itaconate, glycidyl acrylate, glycidyl methacrylate and alicyclic glycidyl esters and ethers; and
vinyl esters of saturated carboxylic acids, especially vinyl acetate or vinyl propionate.

The functionalized polyolefin may be obtained by copolymerizing ethylene with at least one unsaturated polar monomer chosen from the above list. The functionalized polyolefin may be a copolymer of ethylene with a polar monomer from the above list or else a terpolymer of ethylene with two unsaturated polar monomers chosen from the above list. The copolymerization takes place at high pressure, above 1000 bar according to the high-pressure process. The functional polyolefin obtained by copolymerization comprises, by weight, from 50 to 99.9%, preferably from 60 to 99.9%, more preferably still from 65 to 99% of ethylene and from 0.1 to 50%, preferably from 0.1 to 40%, more preferably still from 1 to 35% of at least one polar monomer from the above list.

For example, the functionalized polyolefin is a copolymer of ethylene with an unsaturated epoxide, preferably glycidyl (meth)acrylate, and optionally with a C₁-C₈ alkyl (meth)acrylate or a vinyl ester of a saturated carboxylic acid. The unsaturated epoxide content, especially the glycidyl (meth)acrylate content, is between 0.1 and 50%, advantageously between 0.1 and 40%, preferably between 1 and 35%, more preferably still between 1 and 20%. For example, the functionalized polyolefins may be those sold by ARKEMA under the references LOTADER AX8840 (8% glycidyl methacrylate, 92% ethylene, melt index 5 according to ASTM D1238), LOTADER AX8900 (8% glycidyl methacrylate, 25% methyl acrylate, 67% ethylene, melt index 6 according to ASTM D1238), LOTADER AX8950 (9% glycidyl methacrylate, 15% methyl acrylate, 76% ethylene, melt index 85 according to ASTM D1238).

The functionalized polyolefin may also be a copolymer of ethylene with an unsaturated carboxylic acid anhydride, preferably maleic anhydride, and optionally with a C₁-C₈ alkyl (meth)acrylate or a vinyl ester of a saturated carboxylic acid. The content of maleic anhydride, especially maleic anhydride, is between 0.1 and 50%, advantageously between 0.1 and 40%, preferably between 1 and 35%, more preferably still between 1 and 10%. For example, the functionalized polyolefins may be those sold by ARKEMA under the references LOTADER 2210 (2.6% maleic anhydride, 6% butyl acrylate and 91.4% ethylene, melt index 3 according to ASTM D1238), LOTADER 3340 (3% maleic anhydride, 16% butyl acrylate and 81% ethylene, melt index 5 according to ASTM D1238), LOTADER 4720 (0.3% maleic anhydride, 30% ethyl acrylate and 69.7% ethylene, melt index 7 according to ASTM D1238), LOTADER 7500 (2.8% maleic anhydride, 20% butyl acrylate and 77.2% ethylene, melt index 70 according to ASTM D1238), OREVAC 9309, OREVAC 9314, OREVAC 9307Y, OREVAC 9318, OREVAC 9304 or OREVAC 9305.

Also denoted by the term “functionalized polyolefin” is a polyolefin onto which an unsaturated polar monomer from the above list is grafted by radical means. The grafting takes place in an extruder or in solution in the presence of a radical initiator. As examples of radical initiators, it will be possible to use tert-butyl hydroperoxide, cumene hydroperoxide, diisopropylbenzene hydroperoxide, di-tert-butyl peroxide, tert-butylcumyl peroxide, dicumyl peroxide, 1,3-bis(tert-butylperoxyisopropyl)benzene, benzoyl peroxide, isobutyryl peroxide, bis(3,5,5-trimethylhexanoyl)peroxide or methyl ethyl ketone peroxide. The grafting of an unsaturated polar monomer onto a polyolefin is known to a person skilled in the art, and for further details reference may be made, for example, to documents EP 689505, U.S. Pat. No. 5,235,149, EP 658139, U.S. Pat. No. 6,750,288 B2, U.S. Pat. No. 6,528,587 B2. The polyolefin to which the unsaturated polar monomer is grafted may be a polyethylene, especially high-density polyethylene (HDPE) or low-density polyethylene (LDPE), linear low-density polyethylene (LLDPE) or very low-density polyethylene (VLDPE). The polyethylene may be obtained using a Ziegler-Natta, Phillips or metallocene-type catalyst or using the high-pressure process. The polyolefin may also be a polypropylene, especially an isotactic or syndiotactic polypropylene. It may also be a copolymer of ethylene and propylene of the EPR type, or a terpolymer of ethylene, a propylene and a diene, of the EPDM type. It may, for example, be one of the functionalized polyolefins sold by ARKEMA under the references OREVAC 18302, 18334, 18350, 18360, 18365, 18370, 18380, 18707, 18729, 18732, 18750, 18760, PP-C, CA100.

The polymer onto which the unsaturated polar monomer is grafted may also be a copolymer of ethylene with at least one unsaturated polar monomer chosen from:
C₁-C₈ alkyl (meth)acrylates, especially methyl, ethyl, propyl, butyl, 2-ethylhexyl, isobutyl or cyclohexyl (meth)acrylate; and
vinyl esters of saturated carboxylic acids, especially vinyl acetate or vinyl propionate.

It may, for example, be one of the functionalized polyolefins sold by ARKEMA under the references OREVAC 18211, 18216 or 18630.

Preferably, the functionalized polyolefin is chosen so that the functional groups of the unsaturated monomer which is grafted to the fluoropolymer react with those of the polar monomer of the functionalized polyolefin. For example, if a carboxylic acid anhydride, for example maleic anhydride, is grafted onto the fluoropolymer, the layer of functionalized polyolefin may be composed of a copolymer of ethylene with an unsaturated epoxide, for example glycidyl methacrylate, and optionally with an alkyl acrylate, the ethylene copolymer optionally being blended with a polyolefin.

According to another example, if an unsaturated epoxide, for example glycidyl methacrylate, is grafted onto the fluoropolymer, the layer of functionalized polyolefin may be composed of a copolymer of ethylene with a carboxylic acid anhydride, for example maleic anhydride, and optionally with an alkyl acrylate, the ethylene copolymer optionally being blended with a polyolefin.

The multilayer pipe and all its possible variants will now be described in greater detail.

The multilayer pipe comprises (in the following order, from the inside of the pipe outward):
optionally, a layer C₁ comprising at least one fluoropolymer;
a layer C₂ comprising a blend of:
   at least one copolymer comprising at least one fluoromonomer and at least one monomer bearing a functional group chosen from the following groups: carboxylic acid, carboxylic acid salt, carbonate, carboxylic acid anhydride, epoxide, carboxylic acid ester, silyl, alkoxysilane, carboxylic acid amide, hydroxy or isocyanate; and
   at least one flexible fluoropolymer that has a tensile modulus between 50 and 1000 MPa (measured according to the ISO R 527 standard at 23° C.), advantageously between 100 and 750 MPa and preferably between 200 and 600 MPa;
optionally, an adhesive tie layer C₃;
a layer C₄ comprising at least one polyolefin or a blend of at least one polyolefin with at least one functionalized polyolefin;
a barrier layer C₅ which is a metal sheath or which comprises EVOH or an EVOH-based blend, a PVDF or a PGA; and
optionally, a layer C₆ comprising at least one polyolefin.

According to one variant, layer C₃ is directly attached to layer C₂. According to another variant, layer C₄ is directly attached to the optional layer C₃ or else to layer C₂. According to another variant, the pipe comprises a layer C₁, a layer C₂, a layer C₃ directly attached to layer C₂, a layer C₄ directly attached to layer C₃, a layer C₅ and a layer C₆.

The inner layer which is in contact with the fluid is either layer C₁ or layer C₂. All the layers of the pipe are preferably concentric. The pipe is preferably cylindrical. Preferably, the layers adhere to one another in their respect contact regions (that is to say that two successive layers are directly attached to one another).

### Advantages of the Multilayer Pipe

The multilayer pipe:
exhibits chemical resistance (via layer C₁ and/or C₂) to the transported fluid;
stops the migration of contaminants from the external environment into the transported fluid;
stops the migration of contaminants present in the polyolefin from layer C₄ and/or layer C₆ into the transported fluid;
stops the migration of oxygen or additives present in the transported fluid into layer C₄; and
exhibits very good adhesion between the layers (no delamination).

### Optional Layer C₁

This layer comprises at least one fluoropolymer (this fluoropolymer is not modified by radiation grafting). Preferably, the fluoropolymer is a PVDF homopolymer or copolymer or else a copolymer based on VDF and on TFE of the EFEP type.

### Layer C₂

This layer comprises a blend of at least one functionalized fluoropolymer and at least one flexible fluoropolymer. It has a chemical protection role and exhibits adhesion with layer C₃ or C₄. It also has a role of adhesion tie between the polyolefin layer and the fluoropolymer layer when the latter is present. This blend makes it possible to obtain a very strong adhesion, which is furthermore of the cohesive type.

The blend comprises, by weight, from 1 to 99 parts, advantageously from 10 to 90 parts, preferably from 10 to 75 parts, more preferably still from 10 to 50 parts of a functionalized fluoropolymer per 99 to 1 parts, advantageously 90 to 10 parts, preferably 90 to 25 parts, more preferably still 90 to 50 parts respectively of a flexible fluoropolymer.

Preferably, the viscosity of the functionalized fluoropolymer (measured with a capillary rheometer at 230° C. and 100 s⁻¹) is between 100 and 1500 Pa·s, advantageously between 200 and 1000 Pa·s and preferably between 500 and 1000 Pa·s.

Preferably, the viscosity of the flexible fluoropolymer (measured with a capillary rheometer at 230° C. and 100 s⁻¹) is between 100 and 1500 Pa·s, advantageously between 200 and 1000 Pa·s and preferably between 500 and 1000 Pa·s.

Preferably, the crystallization temperature of the flexible fluoropolymer (measured by DSC according to the ISO 11357-3 standard) is between 50 and 120° C., preferably between 85 and 110° C.

Preferably, the functionalized fluoropolymer is a radiation-grafted fluoropolymer. Preferably, it is a radiation-grafted PVDF. Advantageously, the radiation-grafted PVDF is obtained from a PVDF comprising, by weight, at least 80%, advantageously at least 90%, preferably at least 95%, more preferably still at least 98% of VDF. Most preferably, it is a PVDF homopolymer (that is to say with 100% VDF).

Preferably, the flexible fluoropolymer is a PVDF copolymer, more particularly a VDF/HFP copolymer.

### Optional Layer C₃

Layer C₃ which is positioned between layer C₂ and layer C₄ has the role of increasing the adhesion between these two layers. It comprises an adhesion tie, that is to say a polymer which has the role of improving the adhesion between these two layers.

The adhesion tie may, for example, comprise at least one functionalized polyolefin optionally blended with a polyolefin. In the case where a blend is used, this blend comprises, by weight, from 1 to 99%, advantageously from 10 to 90%, preferably from 50 to 90% of functionalized polyolefin per 99 to 1%, advantageously 90 to 10%, preferably 50 to 10% respectively of polyolefin. The polyolefin which is used for the blend with the functionalized polyolefin is preferably a polyethylene since these two polymers exhibit good compatibility. Layer C₃ may also comprise a blend of two or more functionalized polyolefins. For example, it may be a blend of a copolymer of ethylene with an unsaturated epoxide and optionally with an alkyl (meth)acrylate and a copolymer of ethylene with an alkyl (meth)acrylate.

### Layer C₄

Layer C₄ comprises at least one polyolefin. It may also comprise at least one polyolefin as a blend with at least one functionalized polyolefin. In this case, the blend comprises, by weight, from 1 to 99%, advantageously from 10 to 90%, preferably from 10 to 50% of functionalized polyolefin per 99 to 1%, advantageously 90 to 10%, preferably 90 to 50% respectively of polyolefin. The polyolefin which is used for the blend with the functionalized polyolefin is preferably a polyethylene since these two polymers exhibit good compatibility.

In the case of such a blend, layer C₃ may be eliminated if a functionalized polyolefin which has functional groups capable of reacting with the functional groups grafted onto the fluoropolymer is used. Thus, for example, if anhydride functional groups are grafted onto the fluoropolymer, the functionalized polyolefin will advantageously comprise epoxide or hydroxyl functional groups. For example too, if epoxide or hydroxyl functional groups are grafted onto the fluoropolymer, the functionalized polyolefin advantageously comprises anhydride functional groups. Similarly, this is also true for the functionalized polyolefin of layer C₃. The multilayer pipe therefore comprises (in the following order, from the inside of the pipe outward):
optionally a layer C₁ of at least one fluoropolymer;
a layer C₂ comprising a blend of at least one functionalized fluoropolymer and at least one flexible fluoropolymer;
a layer C₄ of at least one blend of a polyolefin and of at least one functionalized polyolefin which has functional groups capable of reacting with the functional groups grafted onto the fluoropolymer;
a barrier layer C₅ which is a metal sheath or which comprises EVOH or an EVOH-based blend, PVDF or PGA; and
optionally, a layer C₆ of a polyolefin.

### Barrier Layer C₅

The role of the barrier layer is to prevent contamination of the fluid which flows, especially transported water or gas, by contaminants. Oxygen and chemicals such as hydrocarbons, for example, are contaminants. In the more specific case of gases, moisture may be a contaminant.

The barrier layer may be a metal sheath. Besides its barrier function, the metal sheath also has the role of increasing the mechanical strength of the pipe. Another advantage of using a metal sheath is being able to bend or deform the pipe without it returning to its initial position under the effect of the mechanical stresses created by the layers of thermoplastic polymers. The metal may be steel, copper or aluminum or an aluminum alloy. It is preferably aluminum or an aluminum alloy for reasons of corrosion resistance and flexibility. The metal sheath is manufactured according to one of the processes known to a person skilled in the art. Reference may especially be made to the following documents which describe processes enabling composite plastic/metal pipes to be produced: U.S. Pat. No. 6,822,205, EP 0581208 A1, EP 0639411 B1, EP 0823867 B1, EP 0920972 A1. Preferably, use is made of the process consisting in:
shaping a metal strip so as to go around the already coextruded thermoplastic polymer layers (i.e. layers C₁ to C₄), said metal strip having longitudinal edges that are angled toward a common side and placed so as to bear against one another, extending approximately parallel to the longitudinal axis of the plastic pipe; and
the longitudinal edges are then welded together. They therefore form a longitudinal weld seam.

After having welded the longitudinal edges of the metal strip, a tubular metal sheath is therefore obtained.

To improve the adhesion of the barrier layer C₅, an adhesion tie layer is advantageously positioned between the barrier layer C₅ and the polyolefin layer C₄ and/or between the barrier layer C₅ and the optional polyolefin layer C₆. The adhesion tie is, for example, a functionalized polyolefin. It is advantageously a polyolefin, grafted onto which is a carboxylic acid or a carboxylic acid anhydride, for example (meth)acrylic acid or maleic anhydride. It may therefore be a polyethylene onto which (meth)acrylic acid or maleic anhydride is grafted or a polypropylene onto which (meth)acrylic acid or maleic anhydride is grafted. Mention may be made, by way of example, of the functionalized polyolefins sold by ARKEMA under the references OREVAC 18302, 18334, 18350, 18360, 18365, 18370, 18380, 18707, 18729, 18732, 18750, 18760, PP-C, CA100 or by UNIROYAL CHEMICAL under the reference POLYBOND 1002 or 1009 (polyethylene onto which acrylic acid is grafted).

The barrier layer C₅ may also comprise a barrier polymer, for example:
EVOH or an EVOH-based blend;
a PVDF; or
poly(glycolic acid) (PGA).

EVOH is also referred to as saponified ethylene/vinyl acetate copolymer. This is a copolymer having an ethylene content of 20 to 70 mol %, preferably from 25 to 70 mol %, the degree of saponification of its vinyl acetate component not being less than 95 mol %. EVOH constitutes a good oxygen barrier. Advantageously, EVOH has a melt flow index between 0.5 and 100 g/10 min (230° C./2.26 kg), preferably between 5 and 30. It is understood that EVOH may contain small amounts of other comonomer ingredients, including α-olefins such as propylene, isobutene, α-octene, unsaturated carboxylic acids or their salts, partial alkyl esters, full alkyl esters, etc.

For EVOH-based blends, the EVOH forms the matrix, that is to say represents at least 40%, and preferably at least 50%, by weight of the blend.

PGA denotes poly(glycolic acid), that is to say a polymer containing, by weight, at least 60%, advantageously 70%, preferably 80% of the following units (1):

(—O—CH₂—C(═O)—) (1)

This polymer may be manufactured by heating 1,4-dioxane-2,5-dione at a temperature between 120 and 250° C. in the presence of a catalyst such as a tin salt, for example SnCl₄. The polymerization takes place in bulk or in a solvent. The PGA may contain the other following units (2) to (6):

(—O—(CH₂)ₙ—O—C(═O)—(CH₂)ₘ—C(═O)) (2)

where n is an integer between 1 and 10 and m is an integer between 0 and 10;

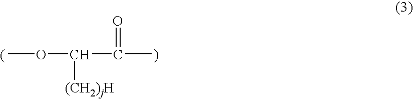

where j is an integer between 1 and 10;

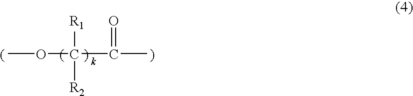

where k is an integer between 2 and 10 and R₁ and R₂ each denote, independently of one another, H or a C₁-C₁₀ alkyl group;

(—OCH₂CH₂CH₂—O—C(═O)—) (5) or

(—O—CH₂—O—CH₂CH₂—) (6)

PGA is described in European Patent EP 925 915 B1.

### Optional Layer C₆

The pipe may optionally include a layer C₆ comprising at least one polyolefin. The polyolefins of layers C₄ and C₆ may be identical or different. Layer C₆ makes it possible to mechanically protect the pipe (e.g. against impacts on the pipe when it is installed), in particular to protect layer C₄ or barrier layer C₅ when the latter is present. It also makes it possible to mechanically reinforce the entire pipe, which may make it possible to reduce the thicknesses of the other layers. In order to do this, layer C₆ may include at least one reinforcing agent, for example a mineral filler.

Owing to its good thermomechanical properties, XPE is advantageously used for layer C₄ and/or for layer C₆.

Each of the layers of the multilayer pipe, especially the polyolefin layer or layers, may contain additives commonly blended into thermoplastics, for example antioxidants, lubricants, colorants, fire retardants, mineral or organic fillers, antistatic agents such as, for example, carbon black or carbon nanotubes. The pipe may also comprise other layers, for example an insulating outer layer.

### Multilayer Pipe According to a Preferred Variant (Best Mode)

The multilayer pipe comprises (in the following order, from the inside of the pipe outward):
optionally, a layer C₁ comprising at least one PVDF homopolymer or copolymer;
a layer C₂ comprising a blend of at least one PVDF homopolymer or copolymer onto which maleic anhydride has been radiation-grafted and of at least one flexible PVDF;
an adhesion tie layer C₃;
a layer C₄ comprising at least one polyethylene, preferably of XPE type;
a barrier layer C₅; and
optionally, a polyethylene layer C₆, preferably of the XPE type.

The adhesion tie preferably comprises at least one functionalized polyolefin which has functional groups capable of reacting with the maleic anhydride, optionally blended with a polyolefin. Advantageously, this is a functionalized polyolefin having epoxide or hydroxyl functional groups. For example, it may be a copolymer of ethylene, an unsaturated epoxide, for example glycidyl methacrylate, and optionally an alkyl acrylate.

Preferably, the barrier layer C₅ is a metal sheath.

### Thickness of the Layers

Preferably, layers C₁, C₂, C₃ and C₅ each have a thickness between 0.01 and 30 mm, advantageously between 0.05 and 20 mm, preferably between 0.05 and 10 mm. The polyolefin layers C₄ and C₆ preferably each have a thickness between 0.1 and 10 000 mm, advantageously between 0.5 and 2000 mm, preferably between 0.5 and 1000 mm. The layer or layers comprising the adhesion tie have a thickness between 0.001 and 30 mm, advantageously between 0.001 and 10 mm.

### Production of the Pipes

The pipes without a metal sheath are manufactured by coextrusion. When the polyolefin of layer C₄ and/or of optional layer C₆ is a type-B XPE (crosslinking via silane groups), the process starts by extruding the uncrosslinked polyolefin. The crosslinking is carried out after the coextrusion of layers C₂ and C₄, and optionally layers C₁ and C₃, has finished, by heating the extruded pipes, for example by immersing them in a bath of hot water. When the polyolefin of layer C₄ and/or optional layer C₆ is a type-A XPE (crosslinking using a radical initiator), the crosslinking is carried out using a radical initiator which is thermally activated during the extrusion.

The pipes with a metal sheath are manufactured after coextrusion of layers C₁ to C₄, and of the optional adhesion tie layer between layer C₅ and layer C₄, then a metal strip is wound around the layers thus obtained. The longitudinal edges may be welded together to form a longitudinal weld seam. It is then possible to extrude layer C₆ and optionally an adhesion tie layer between layer C₅ and layer C₆. When the polyolefin of layer C₄ and/or of optional layer C₆ is a type-B XPE, the crosslinking takes place by heating the pipes, for example by immersing them in a bath of hot water.

### Uses of the Pipe

The multilayer pipe may be used for transporting various fluids. The pipe is suitable for transporting water, especially hot water, in particular for transporting mains hot water. The pipe may be used for transporting hot water for heating (temperature above 60° C., or even 90° C.). One advantageous application example is that of radiant floor heating in which the pipe used for conveying the hot water is placed beneath the floor. The water is heated by a boiler and flows through the pipe. Another example is that in which the pipe is used to convey hot water to a radiator. The pipe can therefore be used for radiant water heating systems. The invention also relates to a network heating system comprising the pipe of the invention.

The chemical resistance of the pipe is adapted to water containing chemical additives (generally in small amounts, of less than 1%) which may impair the polyolefins, especially polyethylene, in particular when hot. These additives may be oxidizing agents such as chlorine and hypochlorous acid, chlorinated derivatives, bleach, ozone, etc.

For applications in which the water flowing in the pipes is a potable water, a water intended for medical or pharmaceutical applications or a biological liquid, it is preferable to have a layer of an unmodified fluoropolymer as a layer in contact with the water (layer C₁). Microorganisms (bacteria, germs, molds, etc.) have little tendency to grow on a fluoropolymer, especially on PVDF. Furthermore, it is preferable for the layer in contact with the water or the biological liquid to be a layer of unmodified fluoropolymer rather than a layer of modified fluoropolymer in order to prevent the migration of ungrafted (free) unsaturated monomer into the water or the biological liquid.

The barrier properties of the pipe make it usable for transporting water in contaminated ground by stopping the migration of contaminants into the transported fluid. The barrier properties are also useful for preventing the migration of oxygen into the water (DIN 4726), which may be damaging in the case where the pipe is used to transport hot water for heating (the presence of oxygen is a source of corrosion of steel or iron components of the heating installation). It is also desirable to stop the migration of contaminants present in the polyolefin layer (antioxidants, polymerization residues, etc.) into the transported fluid.

More generally, the multilayer pipe can be used for transporting chemicals, especially those capable of chemically degrading polyolefins.

The multilayer pipe may also be used for transporting a gas, especially a pressurized gas. When the polyolefin is a polyethylene of the PE80 or PE100 type, it is especially suitable for withstanding pressures above 10 bar, or even above 20 bar, or even still above 30 bar. The gas may be of varying nature. It may be, for example:
a gaseous hydrocarbon (for example, town gas, a gaseous alkane, especially ethane, propane or butane, a gaseous alkene, especially ethylene, propylene or butene);
nitrogen;
helium;
hydrogen;
oxygen; or
a gas that is corrosive or capable of degrading polyethylene or polypropylene. For example, it may be an acidic or corrosive gas, such as H₂S or HCl or HF.

Mention will also be made of the advantage of these pipes for applications associated with air-conditioning, in which the gas flowing in the pipes is a cryogen. It may be CO₂, especially supercritical CO₂, an HFC or HCFC gas. The optional layer C₁ or else layer C₂ exhibits good resistance to these gases, as it is a fluoropolymer. Preferably, the fluoropolymer of layers C₁ and C₂ is PVDF, as it is particularly resistant. It is possible for the cryogen to condense at certain points in the air-conditioning circuit and to be liquid. The multilayer pipe can therefore also apply to the case in which the cryogenic gas has condensed into liquid form.

### The Fluid May Also be a Fuel, for Example a Petrol

The multilayer pipe may also be used for transporting a fuel, for example a petrol, especially a petrol that contains an alcohol. The petrol may be, for example, the M15 petrol (15% methanol, 42.5% toluene and 42.5% isooctane), Fuel C (50% toluene, 50% isooctane), CE10 (10% ethanol and 90% of a mix containing 45% toluene and 45% isooctane). It may also be MTBE.

### EXAMPLES

The examples which follow illustrate the improved adhesion when a blend of a flexible fluoropolymer and a functionalized fluoropolymer is used.

### Products Used

KYNAR® 720: a PVDF homopolymer from ARKEMA with a melt flow index of 20 g/10 min (230° C./5 kg) and a melting point of around 170° C.

KYNAR® 710: a PVDF homopolymer from ARKEMA with a melt flow index of 25 g/10 min (230° C./5 kg) and a melting point of around 170° C.

PVDF-1: KYNAR® 720 onto which maleic anhydride had been radiation-grafted. The grafting was carried out by blending KYNAR® 720 in a twin-screw extruder with 2 wt % of maleic anhydride. The blend was granulated and then bagged in aluminum-lined bags, then the bags and their blend were irradiated to 3 Mrad using a cobalt-60 bomb for 17 hours. The product was recovered and vacuum-degassed in order to remove the ungrafted residual maleic anhydride. The content of grafted maleic anhydride was 1% (by infrared spectroscopy). The MFR (melt flow rate) of the PVDF-1 was 13 g/10 min (230° C./5 kg).

PVDF-2: KYNAR® 710 onto which maleic anhydride had been radiation-grafted. The grafting was carried out by blending KYNAR® 710 in a twin-screw extruder with 2 wt % of maleic anhydride. The blend was granulated and then bagged in aluminum-lined bags, then the bags and their blend were irradiated to 3 Mrad using a cobalt-60 bomb for 17 hours. The product was recovered and vacuum-degassed in order to remove the ungrafted residual maleic anhydride. The content of grafted maleic anhydride was 1% (by infrared spectroscopy). The MFR (melt flow rate) of the PVDF-2 was 16 g/10 min (230° C./5 kg).

LOTADER® AX8840: a copolymer of ethylene (92%) and glycidyl methacrylate (8%) from ARKEMA, having a melt index of 5 according to the ASTM D1238 standard.

XPE: the layer XPE was obtained from a blend containing 95% of the BORPEX® ME-2510 grade and 5% of the MB-51 grade sold by BOREALIS.

The examples relate to multilayer pipes having the following structure:

KYNAR® 720/layer comprising a functionalized fluoropolymer/LOTADER® AX8840/XPE

The KYNAR® 720 layer is the inner layer and the XPE layer is the outer layer. XPE denotes a crosslinked polyethylene obtained from a polyethylene bearing silane functional groups. The XPE layer is obtained by extruding a blend of two products sold by BOREALIS (95 wt % of BORPEX® ME-2510 which is the polyethylene bearing silane functional groups and 5% of MB-51), then by crosslinking the blend by putting the pipes into a bath of hot water (70° C.) for 5 days.

### Example 1 (Comparative)

A multilayer pipe having the following structure was manufactured:

KYNAR® (120 μm)/PVDF-1 (50 μm)/LOTADER® AX8840 (50 μm)/XPE (780 μm)

The pipes were obtained by coextruding a layer of polyethylene modified by silane groups (extrusion temperature of around 230° C.), a layer of LOTADER® AX8840 (extrusion temperature of around 250° C.), a layer of PVDF-1 and a layer of KYNAR® 720 (extrusion temperature of around 250° C.). Next, the pipes were placed in a heated bath in order to obtain the XPE.

The respective thickness of the layers was (for a pipe having an outer diameter of 14 mm) 0.78 mm of XPE, 50 μm of LOTADER® AX8840 and 50 μm of modified KYNAR® 720 and 120 μm of KYNAR® 720. The XPE layer was the outer layer. All the layers adhered to one another.

The adhesion between the grafted KYNAR and LOTADER® AX8840 layers, 5 days after the extrusion, was measured by circumferential peel to be 15 N/cm. The adhesion was of the adhesive failure type.

### Example 2 (According to the Invention)

The conditions from Example 1 were repeated but the PVDF-1 layer was replaced by a layer of a blend comprising 50% of PVDF-1 and 50% of a VDF/HFP copolymer containing 16% HFP and having a viscosity at 230° C. of 900 Pa·s at 100 s⁻¹.

The adhesion between the grafted KYNAR and LOTADER® AX8840 layers, 5 days after the extrusion, was measured by circumferential peel to be 42 N/cm. The adhesion was of the cohesive failure type.

### Example 3 (According to the Invention)

The conditions from Example 1 were repeated but the PVDF-1 layer was replaced by a layer of a blend comprising 50% of PVDF-2 and 50% of a VDF/HFP copolymer containing 16% HFP and having a viscosity at 230° C. of 900 Pa·s at 100 s⁻¹.

The adhesion between the grafted KYNAR and LOTADER® AX8840 layers, 5 days after the extrusion, was measured by circumferential peel to be 45 N/cm. The adhesion was of the cohesive failure type.

### Example 4 (Comparative)

The conditions from Example 1 were repeated but the PVDF-1 layer was replaced by a layer of a blend comprising 50% of PVDF-2 and 50% of a VDF/HFP copolymer containing 16% HFP and having a viscosity at 230° C. of 2300 Pa·s at 100 s⁻¹.

The adhesion between the grafted KYNAR and LOTADER® AX8840 layers, 5 days after the extrusion, was measured by circumferential peel to be 20 N/cm. The adhesion was of the adhesive failure type.

Example 1 shows that when the functionalized fluoropolymer (here, a radiation-grafted PVDF) is not diluted, the layer of this polymer has an adhesion with the LOTADER® AX8840 layer of around 15 N/cm. This adhesion is very substantially improved (Example 2) when the grafted fluoropolymer is diluted in a flexible fluoropolymer. The adhesion is further improved when a flexible fluoropolymer is used in the presence of a more fluid grafted fluoropolymer (Example 3).

TABLE I

| | Layer comprising the | | |
|---|---|---|---|
| | functionalized | Adhesion | Nature of |
| Ex. | fluoropolymer | (N/cm) | the adhesion |
| 1 (comp.) | PVDF-1 | 15 | adhesive |
| 2 (inv.) | 50% PVDF-1 + 50% VDF/HFP | 42 | cohesive |
| | (16%) copolymer having a | | |
| | viscosity of 900 Pa · s at | | |
| | 100 s⁻¹ | | |
| 3 (inv.) | 50% PVDF-2 + 50% VDF/HFP | 45 | cohesive |
| | (16%) copolymer having a | | |
| | viscosity of 900 Pa · s at | | |
| | 100 s⁻¹ | | |
| 4 (comp.) | 50% PVDF-2 + 50% VDF/HFP | 20 | adhesive |
| | (16%) copolymer having a | | |
| | viscosity of 2300 Pa · s at | | |
| | 100 s⁻¹ | | |

1. A multilayer pipe comprising (in the following order, from the inside of the pipe outward):
optionally, a layer C₁ comprising at least one fluoropolymer;
a layer C₂ comprising a blend of:
at least one functionalized fluoropolymer; and
at least one flexible fluoropolymer that has a tensile modulus between 50 and 1000 MPa (measured according to the ISO R 527 standard at 23° C.);
optionally, an adhesive tie layer C₃;
a layer C₄ comprising at least one polyolefin or a blend of at least one polyolefin with at least one functionalized polyolefin;
a barrier layer C₅; and
optionally, a layer C₆ comprising at least one polyolefin.

2. The multilayer pipe as claimed in claim 1, wherein the barrier layer C₅ is a metal sheath or comprises saponified ethylene/vinyl acetate copolymer (EVOH) or an EVOH-based blend, a polyvinylidene fluoride (PVDF) or a poly(glycolic acid) (PGA).

3. The multilayer pipe as claimed in claim 1, wherein the functionalized fluoropolymer is a copolymer comprising at least one fluoromonomer and at least one unsaturated monomer bearing a functional group selected from the group consisting of carboxylic acid, carboxylic acid salt, carbonate, carboxylic acid anhydride, epoxide, carboxylic acid ester, silyl, alkoxysilane, carboxylic acid amide, hydroxy and isocyanate.

4. The multilayer pipe as claimed in claim 1, wherein the functionalized fluoropolymer is obtained by irradiation-grafting of at least one unsaturated monomer onto a fluoropolymer.

5. The multilayer pipe as claimed in claim 4, in which the unsaturated monomer grafted to the fluoropolymer has a C═C double bond and also at least one polar functional group selected from the group consisting of a carboxylic acid, carboxylic acid salt, carboxylic acid anhydride, epoxide, carboxylic acid ester, silyl, alkoxysilane, carboxylic acid amide, hydroxy and isocyanate functional group.

6. The multilayer pipe as claimed in claim 5, in which the unsaturated monomer grafted to the fluoropolymer is an unsaturated carboxylic acid having 4 to 10 carbon atoms and functional derivatives thereof.

7. The multilayer pipe as claimed in claim 5, in which the unsaturated monomer which is grafted is selected from the group consisting of methacrylic acid, acrylic acid, maleic acid, fumaric acid, itaconic acid, citraconic acid, undecylenic acid, allylsuccinic acid, cyclohex-4-ene-1,2-dicarboxylic acid, 4-methylcyclohex-4-ene-1,2-dicarboxylic acid, bicyclo[2.2.1]hept-5-ene-2,3-dicarboxylic acid, x-methylbicyclo[2.2.1]hept-5-ene-2,3-dicarboxylic acid, zinc, calcium or sodium undecylenate, maleic anhydride, itaconic anhydride, citraconic anhydride, dichloromaleic anhydride, difluoromaleic anhydride, itaconic anhydride, crotonic anhydride, glycidyl acrylate or methacrylate, allylglycidyl ether, vinylsilanes, preferably vinyltrimethoxysilane, vinyltriethoxysilane, vinyltri-acetoxysilane and γ-methylacryloxypropyltrimethoxysilane.

8. The multilayer pipe as claimed in claim 1, wherein the viscosity of the functionalized fluoropolymer (measured with a capillary rheometer at 230° C. and 100 s⁻¹) is between 100 and 1500 Pa·s.

9. The multilayer pipe as claimed in claim 1, wherein the viscosity of the flexible fluoropolymer (measured with a capillary rheometer at 230° C. and 100 s⁻¹) is between 100 and 1500 Pa·s.

10. The multilayer pipe as claimed in claim 1, wherein the crystallization temperature of the flexible fluoropolymer (measured by DSC according to the ISO 11357-3 standard) is between 50 and 120° C.

11. The multilayer pipe as claimed in claim 1, in which the fluoropolymer of layer C₁ and/or of layer C₂ is a polymer having, in its chain, at least one monomer chosen from compounds containing a vinyl group capable of opening in order to be polymerized and which contains, directly attached to this vinyl group, at least one fluorine atom, one fluoroalkyl group or one fluoroalkoxy group.

12. The multilayer pipe as claimed in claim 1, in which the fluoropolymer of layer C₁ and/or of layer C₂ is a vinylidenefluoride (VDF) homopolymer or copolymer containing at least 50% by weight of VDF, or else an EFEP.

13. The multilayer pipe as claimed in claim 1, in which the fluoropolymer onto which the unsaturated monomer is grafted is a VDF homopolymer or copolymer containing at least 50% by weight of VDF, or else an EFEP.

14. The multilayer pipe as claimed in claim 1, wherein layer C₃ is directly attached to layer C₂.

15. The multilayer pipe as claimed in claim 1, wherein layer C₄ is directly attached to the optional layer C₃ or else to layer C₂.

16. The multilayer pipe as claimed in claim 1, comprising (in the following order, from the inside of the pipe outward) a layer C₁, a layer C₂, a layer C₃ directly attached to layer C₂, a layer C₄ directly attached to layer C₃, a layer C₅ and a layer C₆.

17. The multilayer pipe as claimed in claim 1, in which the layers adhere to one another in their respective contact regions.

18. The multilayer pipe as claimed in claim 1, in which the adhesion tie comprises at least one functionalized polyolefin optionally blended with a polyolefin.

19. (canceled)

20. The multilayer pipe as claimed in claim 1, in which when layer C₃ is absent and layer C₄ is in direct contact with layer C₂, the functionalized polyolefin of the blend has functional groups capable of reacting with the functional groups grafted onto the fluoropolymer.

21. The multilayer pipe as claimed claim 1, in which the polyolefin of layer C₄ and/or of layer C₆ is a polymer predominantly comprising ethylene and/or propylene units.

22-37. (canceled)
